(19) United States
(12) Patent Application Publication
(10) Pub. No.: US 2026/0255051 A1
(43) Pub. Date: Aug. 27, 2026

(54) SHOOTING METHOD, ELECTRONIC DEVICE AND STORAGE MEDIUM

(71) Applicant: Beijing Zitiao Network Technology Co., Ltd., Beijing (CN)

(72) Inventors: Yunfu WANG, Beijing (CN); Haicun PENG, Beijing (CN); Guocheng YANG, Beijing (CN); Jizhe XIA, Beijing (CN)

(21) Appl. No.: 19/428,764

(22) Filed: Dec. 22, 2025

(30) Foreign Application Priority Data
Feb. 21, 2025 (CN) 202510199124.5

(51) Int. Cl. H04N 23/60; G06F 16/583; H04N 23/69

(52) U.S. Cl. CPC H04N 23/64; G06F 16/583; H04N 23/69

(57) ABSTRACT

The present disclosure provides a shooting method, an electronic device, and a storage medium. The method includes: acquiring at least one shooting reference image of a shooting scene and displaying the shooting reference image in response to an auxiliary shooting start instruction, where the shooting reference image is determined according to scene information of the shooting scene; determining a target reference image among the respective shooting reference images in response to an image determination instruction; acquiring a recommended shooting parameter of the shooting scene based on the target reference image, where the recommended shooting parameter is determined according to a shooting parameter of the target reference image and a device parameter of a terminal device, and the terminal device is configured to shoot the shooting scene; and shooting the shooting scene based on the recommended shooting parameter.

### CROSS-REFERENCE TO RELATED APPLICATION

The present application claims the priority to Chinese Patent Application No. 202510199124.5, filed on February 21, 2025, the entire disclosure of which is incorporated herein by reference as portion of the present application.

### TECHNICAL FIELD

The present disclosure relates to a shooting method, electronic device and storage medium.

### BACKGROUND

When users shoot with a terminal device, shooting parameters of the terminal device are usually set manually, such as manually adjusting parameters of aperture, shutter, focal length, etc. However, with the complication of shooting scenes, the shooting parameters of the terminal device need to be debugged several times to obtain a better shooting effect, which leads to a reduction in shooting efficiency.

### SUMMARY

At least one embodiments of the present disclosure provide a shooting method and apparatus, and a related product, which are capable of recommending corresponding shooting reference images according to a shooting scene and determining recommended shooting parameter of the shooting scene according to a selected target reference image, thus eliminating the tedious process of manually debugging shooting parameters and improving shooting efficiency.

At least one embodiment of the present disclosure provides a shooting method, including:

acquiring at least one shooting reference images of a shooting scene and displaying the shooting reference images in response to an auxiliary shooting start instruction, where the shooting reference images are determined according to scene information of the shooting scene;

determining a target reference image among the respective shooting reference images in response to an image determination instruction;

acquiring recommended shooting parameter of the shooting scene based on the target reference image, where the recommended shooting parameter are determined according to shooting parameters of the target reference image and device parameters of a terminal device, and the terminal device is configured to shoot the shooting scene; and

shooting the shooting scene based on the recommended shooting parameter.

At least one embodiment of the present disclosure further provides a shooting apparatus, including:

a displaying unit, configured to acquire at least one shooting reference images of a shooting scene and display the shooting reference images in response to an auxiliary shooting start instruction, where the shooting reference images are determined according to scene information of the shooting scene;

a determining unit, configured to determine a target reference image among the respective shooting reference images in response to an image determination instruction;

an acquiring unit, configured to acquire recommended shooting parameter of the shooting scene based on the target reference image, where the recommended shooting parameter are determined according to shooting parameters of the target reference image and device parameters of a terminal device, and the terminal device is configured to shoot the shooting scene; and

a shooting unit, configured to shoot the shooting scene based on the recommended shooting parameter.

At least one embodiment of the present disclosure further provides an electronic device, including: a processor; and a memory configured to store computer-executable instructions, where the computer-executable instructions when executed, cause the processor to implement steps of the method according to the foregoing first aspect.

At least one embodiment of the present disclosure further provides a computer-readable storage medium configured to store computer-executable instructions that, when executed by a processor, cause the processor to implement steps of the method according to the foregoing first aspect.

At least one embodiment of the present disclosure further provides a computer program product including a computer program, where the computer program, when executed by a processor, causes the processor to implement steps of the method according to the foregoing first aspect.

### BRIEF DESCRIPTION OF DRAWINGS

In order to more clearly illustrate the technical solutions in one or more embodiments of the present disclosure, the drawings required in describing the embodiments will be briefly introduced below. Obviously, the drawings in the following description illustrate merely some embodiments of the present disclosure, and other drawings may also be obtained by a person of ordinary skill in the art according to these drawings without creative efforts.

FIG. 1 is a schematic flowchart of a shooting method according to at least one embodiment of the present disclosure;

FIG. 2a is a schematic diagram of shooting according to at least one embodiment of the present disclosure;

FIG. 2b is a schematic diagram of shooting according to at least one embodiment of the present disclosure;

FIG. 2c is a schematic diagram of shooting according to at least one embodiment of the present disclosure;

FIG. 3 is a schematic structural diagram of a shooting apparatus according to at least one embodiment of the present disclosure; and

FIG. 4 is a schematic structural diagram of an electronic device according to at least one embodiment of the present disclosure.

### DETAILED DESCRIPTION

In order for persons skilled in the art to better understand the technical solutions in one or more embodiments of the present disclosure, the technical solutions in one or more embodiments of the present disclosure will be described below clearly and comprehensively with reference to the drawings in one or more embodiments of the present disclosure. Obviously, the described embodiments are merely some embodiments of the present disclosure, rather than all the embodiments. All other embodiments obtained by a person of ordinary skill in the art based on one or more embodiments of the present disclosure without creative efforts shall fall within the protection scope of the present disclosure.

It may be understood that before the use of the technical solutions disclosed in the embodiments of the present disclosure, the type of information involved in the present disclosure, the range of use, the use scenarios, etc. shall be informed to the relevant parties and the authorization of the relevant parties shall be obtained in an appropriate manner in accordance with relevant laws and regulations.

For example, in response to reception of an active request from a user, prompt information is sent to the user to clearly inform the user that the requested operation will require access to and use of personal information of the user. In this way, the user may independently choose, according to the prompt information, whether to provide the personal information to software or hardware, such as an electronic device, an application, a server, or a storage medium, etc., that performs the operations of the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may also carry a selection control for the user to choose whether to "agree" or "disagree" to provide the personal information to the electronic device.

It may be understood that the above process of notifying and acquiring user authorization is merely illustrative and does not constitute a limitation on the implementations of the present disclosure, and other manners that satisfy the relevant laws and regulations may also be applied to the implementations of the present disclosure.

At least one embodiment of the present disclosure provides a shooting method, which is capable of recommending a corresponding shooting reference image according to a shooting scene and determining

recommended shooting parameter of the shooting scene according to a selected target reference image, thus eliminating the tedious process of manually debugging shooting parameters and improving shooting efficiency. The shooting method may be performed by a terminal device, which may be a terminal device having a shooting function, such as a mobile phone, a computer, a tablet computer, a notebook computer, a wearable device, a vehicle-mounted computer, or the like, with the shooting function. The shooting involved in various embodiments of the present disclosure includes multiple cases such as taking a photo, shooting a video, shooting a short video, and shooting a gif, where taking a photo includes two cases of shooting a static photo and shooting a dynamic photo.

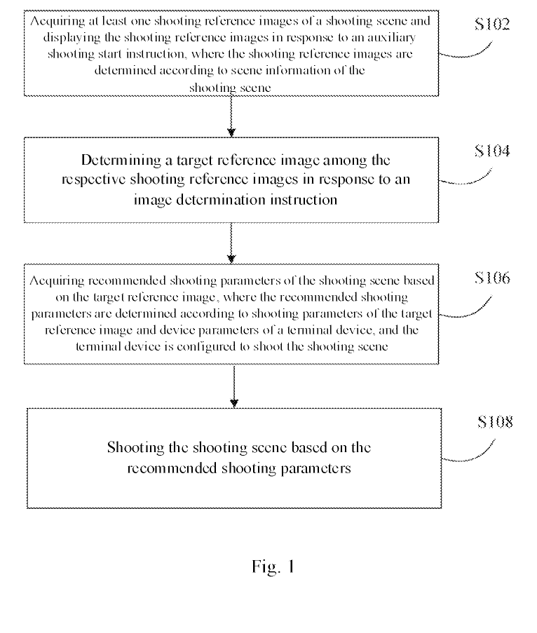

FIG. 1 is a schematic flowchart of a shooting method according to at least one embodiment of the present disclosure. As shown in FIG. 1, the process includes the following steps.

Step S102: acquiring at least one shooting reference image of a shooting scene and displaying the shooting reference image in response to an auxiliary shooting start instruction, where the shooting reference image is determined according to scene information of the shooting scene.

Step S104: determining a target reference image among the respective shooting reference images in response to an image determination instruction.

Step S106: acquiring recommended shooting parameter of the shooting scene based on the target reference image, where the recommended shooting parameter are determined according to shooting parameters of the target reference image and device parameters of a terminal device, and the terminal device is configured to shoot the shooting scene.

Step S108: shooting the shooting scene based on the recommended shooting parameter.

In the at least one embodiment, firstly, at least one shooting reference images of a shooting scene are acquired and the shooting reference images are displayed in response to an auxiliary shooting start instruction, where the shooting reference images are determined according to scene information of the shooting scene; then, a target reference image is determined among the respective shooting reference images in response to an image determination instruction; next, a recommended shooting parameter of the shooting scene is acquired based on the target reference image, where the recommended shooting parameter is determined according to shooting parameters of the target reference image and device parameters of a terminal device, and the terminal device is configured to shoot the foregoing shooting scene; and finally, the foregoing shooting scene is shot based on the recommended shooting parameter. It may be seen that according to the at least one embodiment, a corresponding shooting reference image may be recommended according to a shooting scene, and a recommended shooting parameter of the shooting scene may be determined according to a selected target reference image, thus eliminating the tedious process of manually debugging shooting parameters and improving shooting efficiency.

In the foregoing step S102, the terminal device acquires at least one shooting reference image of a shooting scene and displays the acquired shooting reference image in response to an auxiliary shooting start instruction. In the at least one embodiment, after the shooting function of the terminal device is activated, a

user may perform an auxiliary shooting start operation, and in an example, the auxiliary shooting start operation is an operation in which the user triggers an auxiliary shooting function. The terminal device generates the auxiliary shooting start instruction according to the auxiliary shooting start operation. The terminal device acquires one or more shooting reference images of the shooting scene and displays the acquired shooting reference images in response to the auxiliary shooting start instruction. When there are too many shooting reference images, the user may switch to browse the respective shooting reference images by means of swiping.

In at least one embodiment, the shooting reference image is determined according to the scene information of the shooting scene. In at least one embodiment, the terminal device acquires the scene information of the shooting scene in response to the auxiliary shooting start instruction and uploads the scene information to a server, the server determines one or more shooting reference images of the shooting scene according to the scene information and returns the shooting reference images to the terminal device, and in this way, the terminal device acquires the one or more shooting reference images. In at least one embodiment, the terminal device acquires the scene information of the shooting scene in response to the auxiliary shooting start instruction and determines one or more shooting reference images of the shooting scene according to the scene information, and in this way, the terminal device acquires the one or more shooting reference images.

In at least one embodiment, the following process is further included for acquiring the shooting reference image, where the following process may be performed by the terminal device or the server:

determining scene features of the shooting scene according to the scene information of the shooting scene, where the scene features include at least one of a light feature, a color feature, a scene type feature, or a shot object feature of the shooting scene; and

performing similarity comparison between the scene features of the shooting scene and image features of candidate images stored in a database, and selecting at least one shooting reference image of the shooting scene from the respective candidate images according to a comparison result.

In the at least one embodiment, when the camera of the terminal device is aimed at the shooting scene, a frame of picture may be randomly captured from the shooting scene by the camera, and the picture is used as the scene information of the shooting scene. The scene information of the shooting scene may represent at least one of a light information, color information, scene type information, or shot object information of the shooting scene. The light information is used to represent the degree of light brightness of the shooting scene, the color information is used to represent various colors present in the shooting scene and the area proportion of the various colors, the scene type information is used to represent the scene type of the shooting scene, the scene type includes multiple preset types such as architecture, landscape, indoor, outdoor, festival, portrait, or the like, the shot object information is used to represent the type and number of shot objects in the shooting scene, and the type includes preset types such as person, animal, building, item or the like.

The scene features of the shooting scene may be determined according to the scene information of the shooting scene. The scene features of the shooting scene may be extracted from the scene information of the shooting scene using a convolutional neural network for deep learning. For example, when the camera of the terminal device is aimed at the shooting scene, a frame of picture may be randomly captured from the shooting scene by the camera, the picture is used as the scene information of the shooting scene, the picture is input into a pre-trained convolutional neural network, and the scene features of the shooting scene is extracted by the convolutional neural network. The scene features include at least one of the light feature, the color feature, the scene type feature or the shot object feature of the shooting scene, where the light feature may be represented by brightness values of different areas in the shooting scene, for example, by a light distribution histogram, the color feature may be represented by color values of different areas in the shooting scene, for example, by a color distribution histogram, the scene type feature may be represented by a specific character, the specific character represents a preset type to which the scene type of the shooting scene belongs, the shot object feature may also be represented by a specific character, and the specific character represents a preset type to which the shot object in the shooting scene belongs and the number of shot objects.

Next, similarity comparison is performed between the scene features of the shooting scene and image features of candidate images stored in a database, where the image feature includes at least one of a light feature, a color feature, a scene type feature, or a shot object feature of a candidate image. At least one shooting reference image of the shooting scene is selected from the respective candidate images according to a comparison result. In an example, a similarity degree score between the scene features of the shooting scene and the image features of candidate images stored in the database is calculated using multiple similarity measurement methods such as Euclidean distance, cosine similarity, or the like, and one similarity degree score is obtained through calculation for each candidate image. The higher the score, the more matching the candidate image is with the shooting scene. For example, if the shooting scene is a warm-toned seaside sunset, a candidate image whose color style is warm tone and scene type is seaside sunset will get a higher similarity score. Multiple candidate images with high similarity degree scores are selected as shooting reference images of the shooting scene.

It may be seen that according to the at least one embodiment, it is possible to determine scene features of a shooting scene according to scene information of the shooting scene, perform similarity comparison between the scene features of the shooting scene and image features of candidate images stored in a database, and select at least one shooting reference image of the shooting scene from the respective candidate images according to a comparison result, so as to recommend an appropriate shooting reference image for the shooting scene of the user, thereby realizing precise recommendation of the shooting reference image.

In the foregoing step S104, the terminal device determines a target reference image among the respective shooting reference images in response to an image determination instruction. In the at least one

embodiment, after the shooting reference images are displayed, the user may perform an image selection operation, and the terminal device generates the image determination instruction according to the image selection operation. The terminal device determines a shooting reference image selected by the user among the respective shooting reference images as the target reference image in response to the image determination instruction.

In the foregoing step S106, a recommended shooting parameter of the shooting scene is acquired based on the target reference image. The recommended shooting parameter is determined according to shooting parameters of the target reference image and device parameters of the terminal device, and the terminal device is configured to shoot the foregoing shooting scene. In the at least one embodiment, the terminal device is a device used to shoot the foregoing shooting scene. The recommended shooting parameter of the shooting scene may be determined according to the shooting parameters of the target reference image and the device parameters of the terminal device. When the shooting scene is shot with the recommended shooting parameter, an effect similar to the target reference image may be achieved, thus eliminating the tedious process of manually debugging shooting parameters and improving shooting efficiency.

In at least one embodiment, the terminal device may acquire the shooting parameters of the target reference image and the device parameters of the terminal device, and determine the recommended shooting parameter of the shooting scene according to the shooting parameters of the target reference image and the device parameters of the terminal device. In at least one embodiment, after determining the target reference image according to the image determination instruction, the terminal device may send an identification of the target reference image and the device parameters of the terminal device to a server, and the server may acquire the shooting parameters of the target reference image according to the identification of the target reference image and determine the recommended shooting parameter of the shooting scene according to the shooting parameters of the target reference image and the device parameters of the terminal device.

In at least one embodiment, the shooting parameters of the target reference image include first sensor parameters of a first image sensor that shoots the target reference image, the device parameters of the terminal device include second sensor parameters of a second image sensor of the terminal device and zoom ratios supported by the terminal device, and the following process is further included for determining the recommended shooting parameter, where the following process may be performed by the terminal device or the server:

determining a candidate zoom ratio of the shooting scene according to the first sensor parameters and the second sensor parameters; and

determining a recommended zoom ratio of the shooting scene according to the candidate zoom ratio and the zoom ratios supported by the terminal device, where the recommended shooting parameter include the recommended zoom ratio.

The image sensor is a device used to convert an optical signal into an electronic signal, and shooting of an external scene may be realized by the image sensor. The zoom ratio refers to a multiple by which a framing image is magnified or reduced when the terminal device is shooting. For example, when the terminal device is shooting, the framing image is magnified by two times, and thus the zoom ratio is 2. In the at least one embodiment, the shooting parameters of the target reference image include the first sensor parameters of the first image sensor used by a device that shoots the target reference image, and the device parameters of the terminal device include the second sensor parameters of the second image sensor used by the terminal device and the zoom ratios supported by the terminal device. For example, the terminal device supports 1x, 2x, 3x and 0.5x zoom.

Firstly, the candidate zoom ratio of the shooting scene is determined according to the first sensor parameters and the second sensor parameters, and the candidate zoom ratio is the best zoom ratio matched with the shooting scene. When the terminal device uses the candidate zoom ratio, a shooting effect similar to the target reference image may be achieved.

However, affected by the zoom ratios supported by the terminal device, the candidate zoom ratio may not be achieved in the terminal device. Therefore, it is also necessary to determine the recommended zoom ratio of the shooting scene according to the candidate zoom ratio and the zoom ratios supported by the terminal device. The recommended zoom ratio is a zoom ratio supported by the terminal device, and the recommended shooting parameter includes the recommended zoom ratio. By determining the recommended zoom ratio supported by the terminal device, a shooting effect close to the target reference image may be achieved within a range supported by the terminal device.

It may be seen that according to the at least one embodiment, it is possible to determine a candidate zoom ratio of a shooting scene according to first sensor parameters of a first image sensor used by a device that shoots a target reference image and second sensor parameters of a second image sensor of a terminal device, determine a recommended zoom ratio of the shooting scene according to the candidate zoom ratio and zoom ratios supported by the terminal device, and use the recommended zoom ratio supported by the terminal device as a recommended shooting parameter, so as to achieve a shooting effect close to the target reference image within a range supported by the terminal device.

In at least one embodiments, the shooting parameters of the target reference image further include shooting parameters such as shutter speed, aperture size, ISO sensitivity, or the like, the device parameters of the terminal device further include parameters such as supported shutter speed, aperture size, ISO sensitivity, or the like, and it is also possible to determine at least one of shooting parameters such as recommended shutter speed, recommended aperture size, recommended ISO sensitivity, or the like as the recommended shooting parameter according to the shooting parameters of the target reference image and the device parameters of the terminal device. For example, taking the shutter speed as an example, when the terminal device supports the shutter speed of the target reference image, the shutter speed of the target reference image is used as the recommended shooting parameter, and when the terminal device does not

support the shutter speed of the target reference image, a shutter speed that is supported by the terminal device and closest to the shutter speed of the target reference image is used as the recommended shooting parameter. The same applies to the aperture size and the ISO sensitivity.

In at least one embodiment, the first sensor parameter includes a first diagonal length of the first image sensor, the second sensor parameter includes a second diagonal length of the second image sensor, and the determining a candidate zoom ratio of the shooting scene according to the first sensor parameters and the second sensor parameters includes:

calculating a ratio of the first diagonal length to the second diagonal length; and determining the candidate zoom ratio of the shooting scene according to the ratio.

In the at least one embodiment, the first diagonal length of the first image sensor used by the device that shoots the target reference image is acquired as the first sensor parameter, and the second diagonal length of the second image sensor used by the terminal device is acquired as the second sensor parameter. The first diagonal length is divided by the second diagonal length to obtain a ratio, and the candidate zoom ratio of the shooting scene is determined according to the ratio. For example, the ratio is used as the candidate zoom ratio.

It may be seen that according to the at least one embodiment, it is possible to calculate the ratio of a first diagonal length to a second diagonal length, where the first diagonal length is a diagonal length of a first image sensor used by a device that shoots a target reference image, and the second diagonal length is a diagonal length of a second image sensor used by a terminal device, and determine a candidate zoom ratio of a shooting scene according to the calculated ratio, thereby realizing quick and precise determination of the candidate zoom ratio.

In at least one embodiment, the terminal device supports smooth zoom, and the smooth zoom means that any zoom ratio within a zoom range is supported. For example, the rear camera of the terminal device supports smooth zoom between 0.5x and 3x, and any zoom ratio between 0.5x and 3x may be used for shooting. In this case, the determining a recommended zoom ratio of the shooting scene according to the candidate zoom ratio and the zoom ratios supported by the terminal device includes:

using the candidate zoom ratio as the recommended zoom ratio of the shooting scene if the candidate zoom ratio is a zoom ratio supported by the terminal device; and using, if the candidate zoom ratio is not a zoom ratio supported by the terminal device, a zoom ratio that is supported by the terminal device and has a smallest difference from the candidate zoom ratio as the recommended zoom ratio of the shooting scene.

In the at least one embodiment, it is first determined whether the candidate zoom ratio is a zoom ratio supported by the terminal device. If the candidate zoom ratio is a zoom ratio supported by the terminal device, the candidate zoom ratio is used as the recommended zoom ratio of the shooting scene. If the candidate zoom ratio is not a zoom ratio supported by the terminal device, a zoom ratio that is supported by the terminal device and has a smallest difference from the candidate zoom ratio is used as the recommended zoom ratio of the shooting scene.

For example, the rear camera of the terminal device supports smooth zoom between 0.5x and 3x, and any zoom ratio between 0.5x and 3x may be used for shooting. If the candidate zoom ratio is 1.3x, the recommended zoom ratio is determined to be 1.3x. If the candidate zoom ratio is 4.3x, the recommended zoom ratio is determined to be 3x. If the candidate zoom ratio is 0.4x, the recommended zoom ratio is determined to be 0.5x.

It may be seen that according to the at least one embodiment, it is possible to determine whether a candidate zoom ratio is a zoom ratio supported by a terminal device in a case where the terminal device supports smooth zoom, and accurately determine a recommended zoom ratio based on a determination result.

In at least one embodiment, the terminal device supports discrete zoom, and the discrete zoom means that one or more zoom ratios with fixed values are supported. For example, the front camera of the terminal device supports two zoom ratios, namely, 1x and 1.5x, and the two zoom ratios, namely, 1x and 1.5x may be used for shooting. In this case, the zoom ratios supported by the terminal device have corresponding zoom ratio intervals. For example, a corresponding zoom ratio interval is set for each supported zoom ratio. The determining a recommended zoom ratio of the shooting scene according to the candidate zoom ratio and the zoom ratios supported by the terminal device includes:

using, if the candidate zoom ratio falls within a zoom ratio interval, a zoom ratio corresponding to the zoom ratio interval that the candidate zoom ratio falls within as the recommended zoom ratio of the shooting scene; and determining that there is no recommended zoom ratio of the shooting scene if the candidate zoom ratio does not fall within a zoom ratio interval.

In the present embodiment, it is first determined whether the candidate zoom ratio falls within a zoom ratio interval corresponding to any zoom ratio. If the candidate zoom ratio falls within a certain zoom ratio interval, the zoom ratio corresponding to the zoom ratio interval that the candidate zoom ratio falls within is used as the recommended zoom ratio of the shooting scene. If the candidate zoom ratio does not fall within any zoom ratio interval, it is determined that there is no recommended zoom ratio of the shooting scene.

For example, the front camera of the terminal device supports two zoom ratios, namely, 1x and 1.5x, and the two zoom ratios, namely, 1x and 1.5x may be used for shooting. A zoom ratio interval [0.9, 1.1] is set for the 1x zoom ratio, and a zoom ratio interval [1.2, 1.7] is set for the 1.5x zoom ratio. If the candidate zoom ratio is 0.9x, the recommended zoom ratio is determined to be 1x. If the candidate zoom ratio is 1.4x, the recommended zoom ratio is determined to be 1.5x. If the candidate zoom ratio is 0.4x, it is determined that there is no recommended zoom ratio of the shooting scene.

After it is determined that there is no recommended zoom ratio of the shooting scene, in one case, the process may be terminated, step S108 is not performed, and the shooting parameters (including the zoom ratio) of the terminal device is kept unchanged. In another case, the process may be terminated, step S108 is not performed, and prompt information indicating that the selected target reference image is not supported is output to the user.

It may be seen that according to the at least one embodiment, it is possible to determine whether a candidate zoom ratio falls within a zoom ratio interval in a case where a terminal device supports discrete zoom, and accurately determine a recommended zoom ratio based on a determination result.

In the at least one embodiment, after the recommended zoom ratio is determined and used as the recommended shooting parameter, step S108 is further performed to shoot the shooting scene based on the recommended shooting parameter. In an example, in step S108, the terminal device may achieve the recommended zoom ratio by means of optical zooming first and then digital zooming. Digital zooming may be understood as cropping an image. For example, if the recommended zoom ratio is 2.5x and the terminal device has an optical lens of 2x, the terminal device may first use the optical lens of 2x to perform optical zooming and then perform digital zooming to achieve a zooming effect of 2.5x. In an example, in step S108, the terminal device may automatically shoot the shooting scene based on the recommended shooting parameter, so that after the user selects the target reference image, the user only needs to keep the terminal device still without manual intervention, and an automated shooting process may be realized.

In at least one embodiment, the shooting the shooting scene based on the recommended shooting parameter includes:

adjusting shooting parameters of the terminal device to the recommended shooting parameter, adjusting a framing image of the shooting scene according to the recommended shooting parameter, and displaying the adjusted framing image; and outputting and displaying, in response to a shooting instruction, the adjusted framing image as a shooting result of the shooting scene.

In the at least one embodiment, after the recommended shooting parameter is determined, the shooting parameters of the terminal device are adjusted to the recommended shooting parameter, the framing image of the shooting scene is adjusted according to the recommended shooting parameter, and the adjusted framing image is displayed. For example, the zoom ratio of the terminal device is adjusted to the recommended zoom ratio, the framing image of the shooting scene is magnified or reduced based on the recommended zoom ratio, and the magnified or reduced framing image is displayed. The terminal device may dynamically adjust the size of the framing image according to the recommended zoom ratio and finally display the framing image corresponding to the recommended zoom ratio. By dynamically adjusting the framing image, the user may feel the parameter adjustment process of the terminal device, and the shooting experience may be improved.

Next, if the user performs a shooting operation such as a shooting operation of pressing the shutter or a voice-based shooting operation, the terminal device generates the shooting instruction according to the shooting operation. The terminal device outputs and displays the adjusted framing image as the shooting result of the shooting scene according to the shooting instruction.

It may be seen that according to the at least one embodiment, it is possible to adjust the shooting parameters of the terminal device to the recommended shooting parameter, adjust the framing image of the shooting scene according to the recommended shooting parameter, display the adjusted framing image, where the adjusted framing image is the image to be shot, so that the user may preview the image to be shot in time, and output and display the adjusted framing image as the shooting result of the shooting scene in response to the shooting instruction, thereby achieving the effect of accurately shooting the shooting scene based on the recommended shooting parameter.

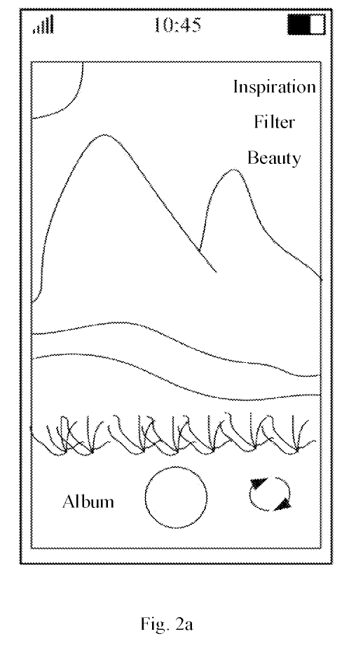

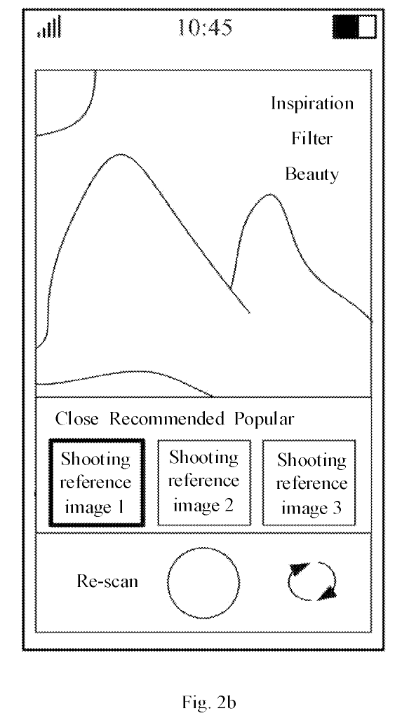

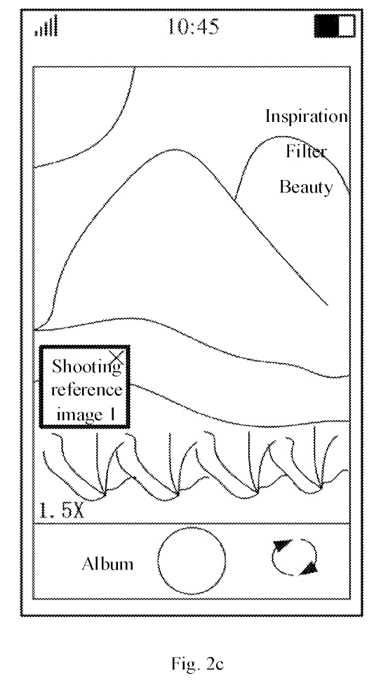

FIG. 2a is a schematic diagram of shooting according to at least one embodiment of the present disclosure, FIG. 2b is a schematic diagram of shooting according to at least one embodiment of the present disclosure, and FIG. 2c is a schematic diagram of shooting according to at least one embodiment of the present disclosure. As shown in FIG. 2a, after the terminal device is activated and enters a shooting interface, if the user triggers an "inspiration" control in the shooting interface, the terminal device generates an auxiliary shooting start instruction based on the triggering operation, randomly captures a frame of picture from a shooting scene by the camera according to the auxiliary shooting start instruction, uses the picture as scene information of the shooting scene, and uploads the scene information to a server. As shown in FIG. 2b, the terminal device also receives multiple shooting reference images of the shooting scene returned by the server according to the scene information, and displays the multiple shooting reference images in the shooting interface. If the user is not satisfied with the recommended shooting reference images, the user may also trigger a "re-scan" control to trigger the terminal device to re-acquire the scene information of the shooting scene and re-recommend shooting reference images. If the user selects a certain shooting reference image, the terminal device generates an image determination instruction according to the selection operation of the user, and determines a target reference image among the respective shooting reference images according to the image determination instruction, where the target reference image may be an image that is bolded and selected as shown in FIG. 2b.

Next, the terminal device acquires the recommended shooting parameter of the shooting scene based on the target reference image, adjusts the shooting parameters to the recommended shooting parameter, adjusts the framing image of the shooting scene according to the recommended shooting parameter, and displays the adjusted framing image. As shown in FIG. 2c, the case where the recommended shooting parameter includes the recommended shooting zoom ratio and the recommended shooting zoom ratio is greater than the initial zoom ratio when the terminal device enters the shooting interface is used as an example for illustration. Compared with FIG. 2b, the terminal device adjusts the zoom ratio to the recommended zoom ratio, magnifies the framing image of the shooting scene according to the recommended

zoom ratio, and displays the magnified framing image. Next, if the user performs a shooting operation, the terminal device generates a shooting instruction according to the shooting operation of the user, and outputs and displays the adjusted framing image as the shooting result of the shooting scene according to the shooting instruction.

It may be seen that according to the example in FIG. 2a to FIG. 2c, a corresponding shooting reference image may be recommended according to a shooting scene, and a recommended shooting parameter of the shooting scene may be determined according to a selected target reference image, thus eliminating the tedious process of manually debugging shooting parameters and improving shooting efficiency.

In at least one embodiment, after the acquiring a recommended shooting parameter of the shooting scene based on the target reference image, the foregoing process further includes:

keeping shooting parameters of a terminal device unchanged as the recommended shooting parameter after any of the following occurs: a shooting interface switches from a foreground state to a background state and returns to the foreground state; and re-entering the shooting interface based on a notification message.

In the at least one embodiment, after the recommended shooting parameter is acquired, in one case, if the shooting interface of the terminal device switches from the foreground state to the background state and returns to the foreground state, for example, the user switches another application to foreground for displaying and switches the shooting interface to background for running, and then the user switches the shooting interface to foreground for displaying again, in this case, the terminal device keeps the shooting parameters of the terminal device unchanged as the foregoing recommended shooting parameter, and after the shooting interface is switched back to the foreground, the terminal device directly displays the framing image of the shooting scene according to the recommended shooting parameter, thereby achieving the effect of retaining the result of the previous shooting operation of the user and continuing shooting.

In another case, the terminal device re-enters the shooting interface based on a notification message, for example, the user triggers the notification message in the terminal device, the notification message points to a shooting application, and the terminal device re-starts the shooting application and displays the shooting interface based on the triggering operation of the user. In this case, the terminal device keeps the shooting parameters of the terminal device unchanged as the foregoing recommended shooting parameter, and the terminal device directly displays the framing image of the shooting scene according to the recommended shooting parameter, thereby achieving the effect of retaining the result of the previous shooting operation of the user and continuing shooting.

In an example, after the user activates the shooting application and enters the shooting interface, the user needs to first click on the "inspiration" control in the shooting interface to browse the respective shooting reference images, and select a target reference image from the respective shooting reference images. Next, the terminal device provides the recommended shooting parameter to the user and displays the framing image of the shooting scene according to the recommended shooting parameter. In this example, if any of the above two cases occurs, the terminal device keeps the shooting parameters of the terminal device unchanged as the foregoing recommended shooting parameter, and directly displays the framing image of the shooting scene according to the recommended shooting parameter, which is equivalent to retaining the results of the previous click operation and selection operation of the user and continuing shooting, thereby saving shooting time and improving shooting efficiency.

It may be seen that according to the at least one embodiment, it is possible to keep the shooting parameters of the terminal device unchanged as the foregoing recommended shooting parameter after the above situation occurs, thereby avoiding re-determination of the recommended shooting parameter, saving shooting time and improving shooting efficiency.

In at least one embodiment, after the acquiring a recommended shooting parameter of the shooting scene based on the target reference image, the foregoing process further includes:

re-determining the recommended shooting parameter if it is detected that the terminal device switches from a first shooting state to a second shooting state, where the first shooting state includes front camera shooting or rear camera shooting, the second shooting state includes front camera shooting or rear camera shooting, and the first shooting state is different from the second shooting state.

If the terminal device switches from the first shooting state to the second shooting state, for example, the terminal device is currently in front camera shooting and switches from the front camera shooting to rear camera shooting, or the terminal device is currently in rear camera shooting and switches from the rear camera shooting to front camera shooting, in this case, the terminal device re-determines the recommended shooting parameter.

When the recommended shooting parameter includes the recommended zoom ratio, in an example, the terminal device is currently in front camera shooting and switches from the front camera shooting to rear camera shooting. In this case, it is necessary to re-determine the recommended zoom ratio of the shooting scene according to the candidate zoom ratio of the shooting scene and the zoom ratios supported by the rear camera through the previous method and process, and control the rear camera to directly switch to the recommended zoom ratio and display the framing image of the shooting scene according to the recommended zoom ratio. If it is determined through the previous method and process that there is no recommended zoom ratio, the rear camera does not respond.

When the recommended shooting parameter includes the recommended zoom ratio, in an example, the terminal device is currently in rear camera shooting and switches from the rear camera shooting to front camera shooting. In this case, it is necessary to re-determine the recommended zoom ratio of the shooting scene according to the candidate zoom ratio of the shooting scene and the zoom ratios supported by the front camera through the previous method and process, and control the front camera to directly switch to the recommended zoom ratio and display the framing image of the shooting scene according to the recommended zoom ratio. If it is determined through the previous method and process that there is no recommended zoom ratio, the front camera does not respond.

It may be seen that according to the at least one embodiment, it is possible to re-determine the recommended shooting parameters when the switching between the front and rear shooting of the terminal device occurs, so as to meet the shooting requirements of users in different situations and improve shooting efficiency.

In at least one embodiment, after the acquiring recommended shooting parameter of the shooting scene based on the target reference image, the foregoing process further includes:

highlighting the recommended shooting parameter; and switching and displaying between the recommended shooting parameter and shooting parameters supported by the terminal device and adjusting the shooting parameters of the terminal device to the displayed shooting parameters in response to a triggering instruction for an area where the recommended shooting parameter is located.

In the at least one embodiment, after the recommended shooting parameter is determined, the recommended shooting parameter may be highlighted in the shooting interface, for example, the recommended shooting parameter is highlighted by means of bolding, highlighting, setting color, etc. It may be referred to FIG. 2c, where the recommended shooting parameter may be displayed in bold in the shooting interface. In addition, if the user triggers the area where the recommended shooting parameter is located, the terminal device switches and displays between the recommended shooting parameter and the shooting parameters supported by the terminal device, and adjusts the shooting parameters of the terminal device to the displayed shooting parameters.

For example, the recommended shooting parameter includes the recommended zoom ratio, the zoom ratios supported by the terminal device include 1x and 2x, and the recommended zoom ratio is 1.5x. If the user clicks on the display area where the recommended zoom ratio is located, the terminal device switches and displays among 1x, 1.5x and 2x zoom, adjusts the zoom ratio of the terminal device to the displayed zoom ratio, and displays the framing image according to the displayed zoom ratio. If the user adjusts the framing image to the recommended zoom ratio by means of pinching, etc., the recommended zoom ratio in the shooting interface may also be continuously highlighted.

It is worth mentioning that the shooting interface described in at least one embodiments of the present disclosure may be an interface that a user enters after activating the shooting function of the terminal device, and the shooting interface includes various controls such as a shutter, multiple shooting modes (portrait, night scene, wide angle, etc.), front and rear lens flipping, zoom ratio switching, or the like.

It may be seen that according to the at least one embodiment, it is possible to highlight the recommended shooting parameter, switch and display between the recommended shooting parameter and the shooting parameter supported by the terminal device in response to the triggering instruction for the area where the recommended shooting parameter is located, adjust the shooting parameters of the terminal device to the displayed shooting parameters, and display the framing image according to the displayed shooting parameters, thereby achieving the effect of connecting the recommended shooting parameter and the shooting parameters supported by the terminal device and switching and displaying of the shooting parameters.

In at least one embodiment, after the acquiring recommended shooting parameter of the shooting scene based on the target reference image, the foregoing process further includes:

restoring shooting parameters of the terminal device to a default shooting parameter or to a shooting parameter sets by a user for the terminal device in response to an auxiliary shooting exit instruction.

In the at least one embodiment, when the user exits auxiliary shooting and returns to conventional shooting, for example, when the user closes the target reference image shown in FIG. 2c and returns to conventional shooting, the terminal device generates an auxiliary shooting exit instruction, and determines, according to the auxiliary shooting exit instruction, whether the user modifies the shooting parameters during the auxiliary shooting process. If the shooting parameters are modified, the shooting parameters of the terminal device are restored to the shooting parameters modified by the user for the terminal device, and if the shooting parameters are not been modified, the shooting parameters of the terminal device are restored to a default preset shooting parameter of the terminal device.

For example, the shooting parameters include the zoom ratio. If the user modifies the zoom ratio during the auxiliary shooting process, the zoom ratio of the terminal device is restored to the zoom ratio modified by the user for the terminal device, and if the user does not modify the zoom ratio during the auxiliary shooting process, the zoom ratio of the terminal device is restored to the default preset zoom ratio of the terminal device.

It may be seen that according to the at least one embodiment, it is possible to restore the shooting parameters of the terminal device to the default shooting parameters or to the shooting parameters set by the user for the terminal device in response to the auxiliary shooting exit instruction, thereby retaining the operation result of the shooting operation of the user and improving the shooting experience of the user.

To sum up, according to the above embodiments, it is possible to recommend corresponding shooting reference images according to a shooting scene and determine a recommended shooting parameter of the shooting scene according to a selected target reference image, thus eliminating the tedious process of manually debugging shooting parameters and improving shooting efficiency.

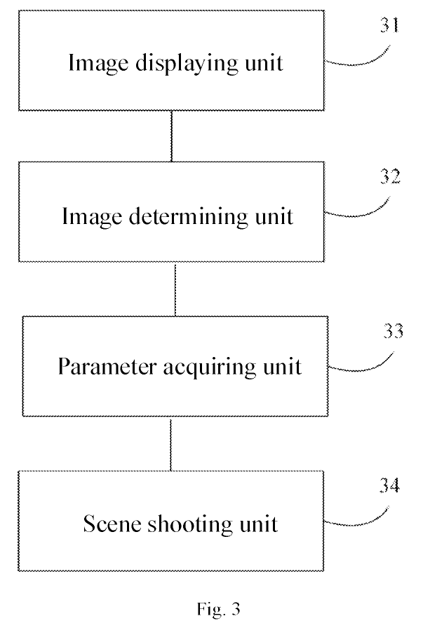

FIG. 3 is a schematic diagram illustrating the structure of a shooting apparatus according to at least one embodiment of the present disclosure. As shown in FIG. 3, the apparatus includes: an image displaying unit 31, an image determining unit 32, a parameter acquiring unit 33, and a scene shooting unit 34

An image displaying unit 31 is configured to acquire at least one shooting reference images of a shooting scene and display the shooting reference images in response to an auxiliary shooting start instruction, where the shooting reference images are determined according to scene information of the shooting scene.

An image determining unit 32 is configured to determine a target reference image among the respective shooting reference images in response to an image determination instruction.

A parameter acquiring unit 33 is configured to acquire a recommended shooting parameter of the shooting scene based on the target reference image, where the recommended shooting parameter is determined according to shooting parameters of the target reference image and device parameters of a terminal device, and the terminal device is configured to shoot the shooting scene.

A scene shooting unit 34 is configured to shoot the shooting scene based on the recommended shooting parameter.

Optionally, an image selecting unit is further included, which is configured to: determine scene features of the shooting scene according to the scene information of the shooting scene, where the scene features include at least one of a light feature, a color feature, a scene type feature, or a shot object feature of the shooting scene; and perform similarity comparison between the scene features of the shooting scene and image features of candidate images stored in a database, and select at least one shooting reference images of the shooting scene from the respective candidate images according to a comparison result.

Optionally, the shooting parameters of the target reference image include first sensor parameters of a first image sensor that shoots the target reference image, the device parameters of the terminal device include second sensor parameters of a second image sensor of the terminal device and zoom ratios supported by the terminal device. Optionally, a parameter determining unit is further included, which is configured to: determine a candidate zoom ratio of the shooting scene according to the first sensor parameters and the second sensor parameters; and determine a recommended zoom ratio of the shooting scene according to the candidate zoom ratio and the zoom ratios supported by the terminal device, where the recommended shooting parameter includes the recommended zoom ratio.

Optionally, the first sensor parameters include a first diagonal length of the first image sensor, the second sensor parameters include a second diagonal length of the second image sensor, and the parameter determining unit is further configured to: calculate a ratio of the first diagonal length to the second diagonal length; and determine the candidate zoom ratio of the shooting scene according to the ratio.

Optionally, the terminal device supports smooth zoom, and the parameter determining unit is further configured to: use the candidate zoom ratio as the recommended zoom ratio of the shooting scene if the candidate zoom ratio is a zoom ratio supported by the terminal device; and use, if the candidate zoom ratio is not a zoom ratio supported by the terminal device, a zoom ratio that is supported by the terminal device and has a smallest difference from the candidate zoom ratio as the recommended zoom ratio of the shooting scene.

Optionally, the terminal device supports discrete zoom, the zoom ratios supported by the terminal device have corresponding zoom ratio intervals, and the parameter determining unit is further configured to: use, if the candidate zoom ratio falls within a zoom ratio interval, a zoom ratio corresponding to the zoom ratio interval that the candidate zoom ratio falls within as the recommended zoom ratio of the shooting scene; and determine that there is no recommended zoom ratio of the shooting scene if the candidate zoom ratio does not fall within the zoom ratio interval.

Optionally, the scene shooting unit is further configured to: adjust shooting parameters of the terminal device to the recommended shooting parameter, adjust a framing image of the shooting scene according to the recommended shooting parameter, and display the adjusted framing image; and output and display the adjusted framing image as a shooting result of the shooting scene in response to a shooting instruction.

Optionally, a parameter keeping unit is further included, which is configured to: after the recommended shooting parameter of the shooting scene is acquired based on the target reference image, keep shooting parameters of the terminal device unchanged as the recommended shooting parameter after any of the following occurs: a shooting interface switches from a foreground state to a background state and returns to the foreground state; and the shooting interface is re-entered based on a notification message.

Optionally, a re-determining unit is further included, which is configured to: after the recommended shooting parameter of the shooting scene is acquired based on the target reference image, re-determine the recommended shooting parameter if it is detected that the terminal device switches from a first shooting state to a second shooting state, where the first shooting state includes front camera shooting or rear camera shooting, the second shooting state includes front camera shooting or rear camera shooting, and the first shooting state is different from the second shooting state.

Optionally, a parameter switching unit is further included, which is configured to: after the recommended shooting parameter of the shooting scene is acquired based on the target reference image, highlight the recommended shooting parameter; and switch and display between the recommended shooting parameter and shooting parameters supported by the terminal device and adjust shooting parameters of the terminal device to the displayed shooting parameters in response to a triggering instruction for an area where the recommended shooting parameter is located.

Optionally, a shooting exiting unit is further included, which is configured to: after the recommended shooting parameter of the shooting scene is acquired based on the target reference image, restore shooting parameters of the terminal device to default shooting parameters or to shooting parameters set by a user for the terminal device in response to an auxiliary shooting exit instruction.

The shooting apparatus in at least one embodiments of the present disclosure may implement each process of the foregoing shooting method embodiments and achieve the same effects and functions, which will not be repeated here.

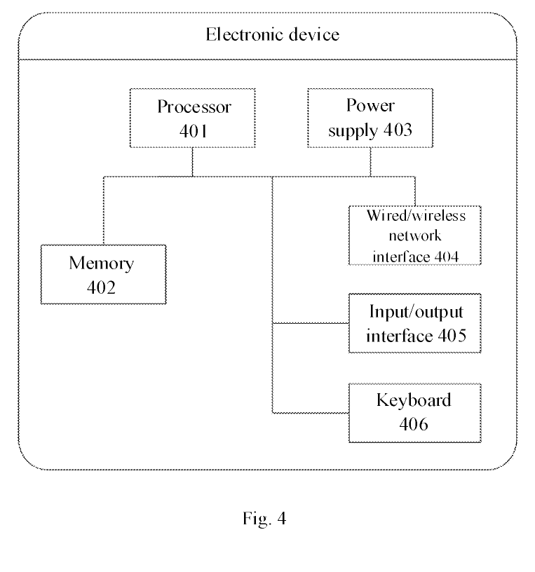

At least one embodiment of the present disclosure further provides an electronic device, and FIG. 4 is a schematic diagram illustrating the structure of an electronic device according to at least one embodiment of the present disclosure. As shown in FIG. 4, the electronic device may vary greatly due to different configurations or performances, and may include one or more processors 401 and memories 402, where the memory 402 may store one or more applications or data. The memory 402 may be temporary storage or persistent storage. The applications stored in the memory 402 may include one or more modules (not shown), and each module may include a series of computer-executable instructions in the electronic device. Furthermore, the processor 401 may be configured to communicate with the memory 402 to execute a series of computer-executable instructions in the memory 402 on the electronic device. The electronic device may further include one or more power supplies 403, one or more wired or wireless network interfaces 404, one or more input or output interfaces 405, one or more keyboards 406, etc. The electronic device may further include shooting components such as a camera.

In at least one embodiment, the electronic device includes a processor; and a memory configured to store computer-executable instructions that, when executed, cause the processor to implement the following processes:

acquiring at least one shooting reference images of a shooting scene and displaying the shooting reference image in response to an auxiliary shooting start instruction, where the shooting reference images are determined according to scene information of the shooting scene;

determining a target reference image among the respective shooting reference images in response to an image determination instruction;

acquiring recommended shooting parameter of the shooting scene based on the target reference image, where the recommended shooting parameter is determined according to shooting parameters of the target reference image and device parameters of a terminal device, and the terminal device is configured to shoot the shooting scene; and

shooting the shooting scene based on the recommended shooting parameter.

The electronic device in at least one embodiments of the present disclosure may implement each process of the foregoing shooting method embodiments and achieve the same effects and functions, which will not be repeated here.

At least one embodiment of the present disclosure further provides a computer-readable storage medium configured to store computer-executable instructions, where the computer-executable instructions, when executed by a processor, implements the following processes:

acquiring at least one shooting reference images of a shooting scene and displaying the shooting reference images in response to an auxiliary shooting start instruction, where the shooting reference images are determined according to scene information of the shooting scene;

determining a target reference image among the respective shooting reference images in response to an image determination instruction;

acquiring recommended shooting parameter of the shooting scene based on the target reference image, where the recommended shooting parameter is determined according to shooting parameters of the target reference image and device parameters of a terminal device, and the terminal device is configured to shoot the shooting scene; and

shooting the shooting scene based on the recommended shooting parameter.

The computer-readable storage medium in at least one embodiments of the present disclosure may implement each process of the foregoing shooting method embodiments and achieve the same effects and functions, which will not be repeated here.

At least one embodiment of the present disclosure further provides a computer program product including a computer program, where the computer program, when executed by a processor, implements the following processes:

acquiring at least one shooting reference images of a shooting scene and displaying the shooting reference images in response to an auxiliary shooting start instruction, where the shooting reference images are determined according to scene information of the shooting scene;

determining a target reference image among the respective shooting reference images in response to an image determination instruction;

acquiring recommended shooting parameter of the shooting scene based on the target reference image, where the recommended shooting parameter is determined according to shooting parameters of the target reference image and device parameters of a terminal device, and the terminal device is configured to shoot the shooting scene; and

shooting the shooting scene based on the recommended shooting parameter.

The computer program product in at least one embodiments of the present disclosure may implement each process of the foregoing shooting method embodiments and achieve the same effects and functions, which will not be repeated here.

In each of the embodiments of the present disclosure, the computer-readable storage medium includes a read-only memory (abbreviated as ROM), a random access memory (abbreviated as RAM), a magnetic disk, an optical disk, or the like.

In the 1990s, an improvement to a technology may be clearly distinguished as an improvement on hardware (for example, an improvement to a circuit structure of a diode, a transistor, a switch, or the like) or an improvement on software (an improvement to a method flow). However, with the development of technologies, many improvements to method flows today may be regarded as direct improvements to hardware circuit structures. Almost all designers obtain corresponding hardware circuit structures by programming improved method flows into hardware circuits. Therefore, it cannot be said that an improvement to a method flow cannot be implemented with a hardware entity module. For example, a programmable logic device (Programmable Logic Device, PLD) (for example, a field programmable gate array (Field Programmable Gate Array, FPGA)) is such an integrated circuit whose logic function is determined by a user programming the device. Instead of asking a chip manufacturer to design and fabricate a dedicated integrated circuit chip, a designer may program by himself to "integrate" a digital system on a PLD. Moreover, today, instead of fabricating an integrated circuit chip manually, this programming is mostly implemented using "logic compiler" software, which is similar to a software compiler used for program development and writing. However, original code before compilation also needs to be written in a specific programming language, which is referred to as a hardware description language (HDL). There is not only one type of HDL, but many types, such as ABEL (Advanced Boolean Expression Language), AHDL (Altera Hardware Description Language), Confluence, CUPL (Cornell University Programming Language), HDCal, JHDL (Java Hardware Description Language), Lava, Lola, MyHDL, PALASM, RHDL (Ruby Hardware Description Language), etc. Currently, the most commonly used are VHDL (Very-High-Speed Integrated Circuit Hardware Description Language) and Verilog. It should also be clear to those skilled in the art that a hardware circuit that implements a logical method flow may be easily obtained by simply performing logical programming on the method flow in the foregoing several hardware description languages and programming the method flow into an integrated circuit.

The controller may be implemented in any appropriate manner, for example, the controller may be in the form of a microprocessor or processor, and a computer-readable medium, a logic gate, a switch, an application specific integrated circuit (ASIC), a programmable logic controller, and an embedded microcontroller that store computer-readable program code (for example, software or firmware) executable by the (micro)processor. Examples of the controller include, but are not limited to, the following microcontrollers: ARC 625D, Atmel AT91SAM, Microchip PIC18F26K20, and Silicone Labs C8051F320. The memory controller may also be implemented as a part of control logic of the memory. Those skilled in the art also know that in addition to implementing the controller in a form of pure computer-readable program code, it is also possible to perform logical programming on method steps to enable the controller to implement the same functions in the form of a logic gate, a switch, a dedicated integrated circuit, a programmable logic controller, an embedded microcontroller, or the like. Therefore, such a controller may be considered as a hardware component, and an apparatus included therein for implementing various functions may also be considered as a structure in the hardware component. Alternatively, even, the apparatus for implementing various functions may be considered as both a software module for implementing the method and a structure in the hardware component.

The system, the apparatus, the module or the unit illustrated in the foregoing embodiments may be implemented specifically by a computer chip or entity, or by a product having a specific function. A typical implementation device is a computer. Specifically, the computer may be, for example, a personal computer, a laptop computer, a cellular phone, a camera phone, a smart phone, a personal digital assistant, a media player, a navigation device, an email device, a game console, a tablet computer, a wearable device, or a combination of any of these devices.

For ease of description, when described, the foregoing apparatus is divided into various units based on functions. Certainly, during implementation of the embodiments of the present disclosure, functions of the units may be implemented in one or more pieces of software and/or hardware.

Persons skilled in the art should understand that one or more embodiments of the present disclosure may be provided as a method, a system, or a computer program product. Therefore, one or more embodiments of the present disclosure may take the form of an entirely hardware embodiment, an entirely software embodiment or an embodiment containing both hardware and software elements. Moreover, one or more embodiments of the present disclosure may take the form of a computer program product implemented on one or more computer-usable storage media (including, but not limited to, disk storage, CD-ROM, optical storage, etc.) having computer-usable program code embodied therein.

The present disclosure is described with reference to flowcharts and/or block diagrams of a method, a device (system), and a computer program product according to embodiments of the present disclosure. It should be understood that each process and/or block in the flowcharts and/or block diagrams, and a combination of processes and/or blocks in the flowcharts and/or block diagrams may be implemented by computer program instructions. These computer program instructions may be provided to a processor of a general-purpose computer, a special-purpose computer, an embedded processor, or another programmable data processing device to produce a machine, such that the instructions, which are executed by the processor of the computer or another programmable data processing device, produce an apparatus for implementing a specific function in one or more processes in the flowcharts and/or in one or more blocks in the block diagrams.

These computer program instructions may also be stored in a computer-readable memory that may direct a computer or another programmable data processing device to work in a specific manner, such that the instructions stored in the computer-readable memory produce a manufactured product including an instruction apparatus, and the instruction apparatus implements a specific function in one or more processes in the flowcharts and/or in one or more blocks in the block diagrams.

These computer program instructions may also be loaded onto a computer or another programmable data processing device, such that a series of operations and steps are performed on the computer or the another programmable device, so as to produce computer-implemented processing. Therefore, the instructions executed on the computer or the another programmable device provide steps for implementing a step of a specific function in one or more processes in the flowcharts and/or in one or more blocks in the block diagrams.

It should also be noted that the terms "includes", "include", or any other variant thereof are intended to cover non-exclusive inclusion, such that a process, a method, a product, or a device that includes a series of elements includes not only those elements, but also other elements not explicitly listed or elements intrinsic to such process, method, product, or device. Without further restrictions, an element defined by the phrase "includes a …" does not exclude the existence of other identical elements in the process, the method, the product, or the device that includes the element.

One or more embodiments of the present disclosure may be described in the general context of computer-executable instructions, such as program modules, executed by a computer. Generally, the program modules include routines, programs, objects, components, data structures, etc. that perform specific tasks or implement specific abstract data types. One or more embodiments of the present disclosure may also be practiced in distributed computing environments in which tasks are performed by remote processing devices connected through a communication network. In the distributed computing environments, the program modules may be located in local and remote computer storage media including storage devices.

The embodiments of the present disclosure are all described in a progressive manner, and parts that are the same or similar among the embodiments may be referred to each other. Each embodiment focuses on a difference from other embodiments. In particular, since the system embodiment is basically similar to the method embodiment, the description is relatively simple, and for related parts, reference may be made to the description of the method embodiment.

The foregoing descriptions are merely embodiments of the present disclosure and are not intended to limit the present disclosure. For persons skilled in the art, the present disclosure may have various modifications and changes. Any modification, equivalent replacement, improvement, etc. made within the spirit and principle of the present disclosure shall fall within the scope of the claims of the present disclosure.

1. A shooting method, comprising:
acquiring, in response to an auxiliary shooting start instruction, at least one shooting reference image of a shooting scene and displaying the shooting reference images, wherein the shooting reference images are determined according to scene information of the shooting scene;
determining a target reference image among the shooting reference images in response to an image determination instruction;
acquiring a recommended shooting parameter of the shooting scene based on the target reference image, wherein the recommended shooting parameter are determined according to a shooting parameter of the target reference image and a device parameter of a terminal device, and the terminal device is configured to shoot the shooting scene; and
shooting the shooting scene based on the recommended shooting parameter.

2. The shooting method of claim 1, further comprising:
determining a scene feature of the shooting scene according to the scene information of the shooting scene, wherein the scene feature comprises at least one of a light feature, a color feature, a scene type feature, or a shot object feature of the shooting scene; and
performing similarity comparison between the scene feature of the shooting scene and image features of candidate images stored in a database, and selecting the at least one shooting reference image of the shooting scene from the candidate images according to a comparison result.

3. The shooting method of claim 1, wherein the shooting parameter of the target reference image comprises a first sensor parameter of a first image sensor that shoots the target reference image, the device parameter of the terminal device comprises a second sensor parameter of a second image sensor of the terminal device and zoom ratios supported by the terminal device, and the shooting method further comprises:
determining a candidate zoom ratio of the shooting scene according to the first sensor parameter and the second sensor parameter; and
determining a recommended zoom ratio of the shooting scene according to the candidate zoom ratio and the zoom ratios supported by the terminal device, wherein the recommended shooting parameter comprises the recommended zoom ratio.

4. The shooting method of claim 3, wherein the first sensor parameter comprises a first diagonal length of the first image sensor, the second sensor parameter comprises a second diagonal length of the second image sensor, and the determining the candidate zoom ratio of the shooting scene according to the first sensor parameter and the second sensor parameter comprises:
calculating a ratio of the first diagonal length to the second diagonal length; and
determining the candidate zoom ratio of the shooting scene according to the ratio.

5. The shooting method of claim 3, wherein the terminal device supports smooth zoom, and the determining the recommended zoom ratio of the shooting scene according to the candidate zoom ratio and the zoom ratios supported by the terminal device comprises:
using the candidate zoom ratio as the recommended zoom ratio of the shooting scene in response to the candidate zoom ratio being a zoom ratio supported by the terminal device; and
using, in response to the candidate zoom ratio being not a zoom ratio supported by the terminal device, a zoom ratio that is supported by the terminal device and has a smallest difference from the candidate zoom ratio as the recommended zoom ratio of the shooting scene.

6. The shooting method of claim 3, wherein the terminal device supports discrete zoom, the zoom ratios supported by the terminal device have corresponding zoom ratio interval, and the determining the recommended zoom ratio of the shooting scene according to the candidate zoom ratio and the zoom ratios supported by the terminal device comprises:
using, in response to that the candidate zoom ratio falls within the zoom ratio intervals, a zoom ratio corresponding to a zoom ratio interval that the candidate zoom ratio falls within as the recommended zoom ratio of the shooting scene; and
determining that there is no recommended zoom ratio of the shooting scene in response to the candidate zoom ratio does not fall within the zoom ratio intervals.

7. The shooting method of claim 1, wherein the shooting the shooting scene based on the recommended shooting parameter comprises:
adjusting a shooting parameter of the terminal device to the recommended shooting parameter, adjusting a framing image of the shooting scene according to the recommended shooting parameter, and displaying an adjusted framing image; and
outputting and displaying the adjusted framing image as a shooting result of the shooting scene in response to a shooting instruction.

8. The shooting method of claim 1, wherein after the acquiring the recommended shooting parameter of the shooting scene based on the target reference image, the shooting method further comprises:
keeping a shooting parameter of the terminal device unchanged as the recommended shooting parameter after any of the following occurs: a shooting interface switches from a foreground state to a background state and returns to the foreground state; or the shooting interface is re-entered based on a notification message.

9. The shooting method of claim 1, wherein after the acquiring the recommended shooting parameter of the shooting scene based on the target reference image, the shooting method further comprises:
re-determining the recommended shooting parameter in response to detecting that the terminal device switches from a first shooting state to a second shooting state, wherein the first shooting state comprises front camera shooting or rear camera shooting, the second shooting state comprises front camera shooting or rear camera shooting, and the first shooting state is different from the second shooting state.

10. The shooting method of claim 1, wherein after the acquiring the recommended shooting parameter of the shooting scene based on the target reference image, the shooting method further comprises:
highlighting the recommended shooting parameter; and
switching and displaying between the recommended shooting parameter and shooting parameters supported by the terminal device and adjusting a shooting parameter of the terminal device to a displayed shooting parameter in response to a triggering instruction for an area where the recommended shooting parameter is located.

11. The shooting method of claim 1, wherein after the acquiring the recommended shooting parameter of the shooting scene based on the target reference image, the shooting method further comprises:
restoring a shooting parameter of the terminal device to a default shooting parameter or to a shooting parameter set by a user for the terminal device in response to an auxiliary shooting exit instruction.

12. An electronic device, comprising:
a processor; and
a memory configured to store computer-executable instructions, where the computer-executable instructions, when executed, cause the processor to implement a shooting method, the shooting method comprises:
acquiring, in response to an auxiliary shooting start instruction, at least one shooting reference image of a shooting scene and displaying the shooting reference images, wherein the shooting reference images are determined according to scene information of the shooting scene;
determining a target reference image among the shooting reference images in response to an image determination instruction;
acquiring a recommended shooting parameter of the shooting scene based on the target reference image, wherein the recommended shooting parameter are determined according to a shooting parameter of the target reference image and a device parameter of a terminal device, and the terminal device is configured to shoot the shooting scene; and
shooting the shooting scene based on the recommended shooting parameter.

13. The electronic device of claim 12, wherein the shooting method further comprises:
determining a scene feature of the shooting scene according to the scene information of the shooting scene, wherein the scene feature comprises at least one of a light feature, a color feature, a scene type feature, or a shot object feature of the shooting scene; and
performing similarity comparison between the scene feature of the shooting scene and image features of candidate images stored in a database, and selecting the at least one shooting reference image of the shooting scene from the candidate images according to a comparison result.

14. The electronic device of claim 12, wherein the shooting parameter of the target reference image comprises a first sensor parameter of a first image sensor that shoots the target reference image, the device parameter of the terminal device comprises a second sensor parameter of a second image sensor of the terminal device and zoom ratios supported by the terminal device, and the shooting method further comprises:
determining a candidate zoom ratio of the shooting scene according to the first sensor parameter and the second sensor parameter; and
determining a recommended zoom ratio of the shooting scene according to the candidate zoom ratio and the zoom ratios supported by the terminal device, wherein the recommended shooting parameter comprises the recommended zoom ratio.

15. The electronic device of claim 14, wherein the first sensor parameter comprises a first diagonal length of the first image sensor, the second sensor parameter comprises a second diagonal length of the second image sensor, and the determining the candidate zoom ratio of the shooting scene according to the first sensor parameter and the second sensor parameter comprises:
calculating a ratio of the first diagonal length to the second diagonal length; and
determining the candidate zoom ratio of the shooting scene according to the ratio.

16. The electronic device of claim 14, wherein the terminal device supports smooth zoom, and the determining the recommended zoom ratio of the shooting scene according to the candidate zoom ratio and the zoom ratios supported by the terminal device comprises:
using the candidate zoom ratio as the recommended zoom ratio of the shooting scene in response to the candidate zoom ratio being a zoom ratio supported by the terminal device; and
using, in response to the candidate zoom ratio being not a zoom ratio supported by the terminal device, a zoom ratio that is supported by the terminal device and has a smallest difference from the candidate zoom ratio as the recommended zoom ratio of the shooting scene.

17. The electronic device of claim 14, wherein the terminal device supports discrete zoom, the zoom ratios supported by the terminal device have corresponding zoom ratio interval, and the determining the recommended zoom ratio of the shooting scene according to the candidate zoom ratio and the zoom ratios supported by the terminal device comprises:
using, in response to that the candidate zoom ratio falls within the zoom ratio intervals, a zoom ratio corresponding to a zoom ratio interval that the candidate zoom ratio falls within as the recommended zoom ratio of the shooting scene; and
determining that there is no recommended zoom ratio of the shooting scene in response to the candidate zoom ratio does not fall within the zoom ratio intervals.

18. The electronic device of claim 12, wherein the shooting the shooting scene based on the recommended shooting parameter comprises:
adjusting a shooting parameter of the terminal device to the recommended shooting parameter, adjusting a framing image of the shooting scene according to the recommended shooting parameter, and displaying an adjusted framing image; and
outputting and displaying the adjusted framing image as a shooting result of the shooting scene in response to a shooting instruction.

19. The electronic device of claim 12, wherein after the acquiring the recommended shooting parameter of the shooting scene based on the target reference image, the shooting method further comprises:
keeping a shooting parameter of the terminal device unchanged as the recommended shooting parameter after any of the following occurs: a shooting interface switches from a foreground state to a background state and returns to the foreground state; or the shooting interface is re-entered based on a notification message.

20. A non-transitory computer-readable storage medium, wherein the computer-readable storage medium is configured to store computer-executable instructions, where the computer-executable instructions, when executed by a processor, implement a shooting method, the shooting method comprises:
acquiring, in response to an auxiliary shooting start instruction, at least one shooting reference image of a shooting scene and displaying the shooting reference images, wherein the shooting reference images are determined according to scene information of the shooting scene;
determining a target reference image among the shooting reference images in response to an image determination instruction;
acquiring a recommended shooting parameter of the shooting scene based on the target reference image, wherein the recommended shooting parameter are determined according to a shooting parameter of the target reference image and a device parameter of a terminal device, and the terminal device is configured to shoot the shooting scene; and
shooting the shooting scene based on the recommended shooting parameter.
